(19) United States
(12) Patent Application Publication
(10) Pub. No.: US 2021/0118133 A1
(43) Pub. Date: Apr. 22, 2021

(54) SYSTEM, METHOD, APPARATUS AND COMPUTER PROGRAM PRODUCT FOR THE DETECTION AND CLASSIFICATION OF DIFFERENT TYPES OF SKIN LESIONS

(71) Applicant: Jason Troy Benkert, Herndon, VA (US)

(72) Inventor: Jason Troy Benkert, Herndon, VA (US)

(21) Appl. No.: 17/072,883

(22) Filed: Oct. 16, 2020

Related U.S. Application Data
(60) Provisional application No. 62/915,826, filed on Oct. 16, 2019.

(51) Int. Cl. G06T 7/00; G06T 5/00

(52) U.S. Cl. CPC G06T 7/0012; G06T 5/003; G06T 2207/30088; G06T 2207/20076; G06T 2207/20081; G06T 2207/20084; G06T 2207/30096

(57) ABSTRACT

A system, method, apparatus and computer program product for the detection and classification of different types of skin lesions that leverages artificial intelligence (AI) is disclosed. SkinScreen® uses a novel approach that we have labeled as ‘serial chain classifiers’. This approach uses a binary classifier, to determine whether a skin lesion is present in the image, then if a lesion is present uses a multi-class classifier to classify the type of skin lesion. This approach removes manual human intervention in the process that is employed by current solutions while improving the accuracy and precision of the results. Using novel techniques of image transformation, the datasets used to train the AI models were expanded by a factor of 8. The larger the dataset, the more accurate and precise the results. These novel approaches have resulted in a better screening detection tool.

### CROSS-REFERENCE TO RELATED APPLICATION

This application claims the benefit of priority of U.S. provisional application No. 62/915,826 filed Oct. 16, 2019, the contents of which are herein incorporated by reference.

### BACKGROUND OF THE INVENTION

The present invention relates to skin lesions, and more particularly methods and apparatus for skin lesion detection and classification.

As more people across the world are being damaged by excessive exposure to harmful ultraviolet (UV) rays, the associated impact is shorter life spans and tremendous medical costs to the Governments and public to treat this issue. Twenty percent of Americans will be diagnosed with skin cancer before age 70 per the American Cancer Association (ACA). The proposed invention, SkinScreen®, relates to skin lesions, and more particularly identification and classification of skin lesions caused by the exposure to UV rays.

Since 1985, doctors have been using a visual heuristic, preoperative based approach known as ABCDE (Asymmetry, Border, Color, Diameter, and Evolving) in the detection of skin lesions. The current heuristic methodology of visual detection and classification of skin lesions lacks precision, accuracy and is time consuming for potentially life-threatening maladies. Current medical studies indicate that trained medical professionals score less than 35% correct in skin lesion classification testing. These trained professionals have no current capability to produce any analytics on the probability of correct diagnosis.

This ADCDE visual/manual approach has proven useful in the detection and classification of skin lesions to an extent, however, it is subject to human error even after being trained. It was clinically proven by June K Robinson, MD and Rob Turrisi, PhD, that this approach is subject to human error. Their clinical study yielded when an individual performs a skin self-exam (SSE) the level of accuracy after being trained on the ABCDE approach varies based on the sex and age of the individual performing the assessment. As a result, this technique was found to be subjective in its approach, inaccurate at times, and results vary by individual trained observer.

As can be seen, there is a need for an improved apparatus and methods for skin lesion detection and classification.

### SUMMARY OF THE INVENTION

In one aspect of the present invention, a method, using image data of a skin anomaly for detection and classification of skin lesions is disclosed. The method includes receiving an image of a skin anomaly from the user. The image of the skin anomaly is useable as an input to an artificial intelligence (AI) model trained using a training data set from an existing training set containing a plurality of verified skin lesion images. A binary classifier is applied to the image of the skin anomaly to determine whether the image of the skin anomaly contains sufficient data indicative of a skin lesion. When insufficient data is present, a response is returned to the user indicating that a lack of data is available to make a prediction indicative of the skin lesion. When sufficient data is present in the image of the skin anomaly, a multi-class classifier of the AI model is applied to apply at least one classification to the image of the skin anomaly.

In some embodiments, the method also includes determining a probability for each of the at least one classification. The probability of the at least one classification may then be returned on a user interface.

In some embodiments, at least some of the plurality of skin lesion images from the existing training set are transformed to expand at least one of a quantity and a quality of the plurality of the verified skin lesion images in the training data set. The transformation may be achieved by applying an image transformation technique selected from the group consisting of zooming, offset, brightening, blurring, sharpening, color change.

In some embodiments, the AI model is deployed to a mobile computing device. The multi-class classifier of the AI model is then applied to the image of the skin anomaly retained locally on the mobile computing device.

In some embodiments, the step of receiving the image of the skin anomaly from the user may include receiving a digital image captured with a digital camera provisioned with a mobile computing device. Alternatively, or in addition to, the step of receiving the image of the skin anomaly may include presenting, in a display, a plurality of images from a user image library accessible by the mobile computing device. A user selection of the image of the skin anomaly from the user image library is then received.

The method may also include the step of converting the AI model to a format configured to run on the mobile device.

In other aspects of the invention, an analysis apparatus configured to use an image of a skin anomaly to determine a classification of a skin lesion is disclosed. The analysis apparatus includes at least one processor configured to execute computer-readable instructions to cause the analysis apparatus to run an artificial intelligence (AI) model to classify the image of the skin anomaly into at least one of a plurality of classifications. The AI model may be trained using a training data set from an existing training set containing a plurality of verified skin lesion images. A binary classifier is applied to the image of the skin anomaly to determine whether the image of the skin anomaly contains sufficient data indicative of a skin lesion. When sufficient data is present in the image of the skin anomaly, a multi-class classifier of the AI model is applied to apply at least one classification to the image of the skin anomaly.

In some embodiments, when insufficient data is present, a response is returned to the user indicating that a lack of data is available to make a prediction indicative of the skin lesion.

In some embodiments, the analysis apparatus may also include determining, by the AI model, a probability for each of the at least one classification and returning, on a user interface, the probability of the at least one classification.

In other embodiments, the existing training set is transformed in at least one of a quantity and a quality of the plurality of the verified skin lesion images to augment the training data set.

In yet other embodiments, an image transformation technique is applied to at least some of the plurality of verified skin lesion images. The image transformation technique is selected from the group consisting of zooming, offset, brightening, blurring, sharpening, color change.

These and other features, aspects and advantages of the present invention will become better understood with reference to the following drawings, description and claims.

### BRIEF DESCRIPTION OF THE DRAWINGS

FIG. 1 is a graph of accuracy versus latency.

FIG. 2 is a diagram illustrating the overview of mobilenetv2 architecture.

FIG. 3 is a screen shot of the application successfully processing a screening.

FIG. 4 is a screen shot of the application unsuccessfully processing a screening.

FIG. 5 is a flow-chart of the screening process.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provide a system, method, apparatus, and computer program product that leverages “big data”, computational power, and Artificial Intelligence, in the detection and classification of benign and malignant skin lesions. Currently, detection is manually performed by a dermatologist or technician through a heuristic approach known as ABCDE (Asymmetry, Border Irregularity, Color, Diameter, and Evolution). This method used by trained professionals is has been tested and is approximately only 35% correct over time.

The inventive SkinScreen® product, according to aspects of the present invention compensates for current physical dataset shortcomings through the unique capability to create data set transformation, which increases the number of data images in which to train the AI software algorithms. Increased precision and accuracy are the result for the AI Algorithms.

SkinScreen's Benefits

In today's business climate, it is imperative for businesses to leverage some form of artificial intelligence (AI) in order to 1) understand the vast amounts of data that are being ingested into their data lakes and 2) make actionable decisions with that knowledge. AI can bring the equivalent of the human cortex—systems that can learn the problem and automatically return an accurate and precise result. Leveraging the vast amounts of data is not within human capabilities by themselves.

SkinScreen® provides the capability to utilize vast amounts of available data within the medical community in order to understand, prioritize, and treat individuals based on their skin lesion condition. SkinScreen® will be a great asset for any medical organization to leverage upon in addressing skin lesion issues and treatments by providing detection and precision within classification that exceed trained human capabilities.

Within the context of artificial intelligence, the algorithms used in defining a curve fitting solution can detect very minute differences between images that are undetectable by human recognition. This allows SkinScreen® to make classifications and create metrics that a trained medical professional would not be able to make even with augmented visual aids such as microscopes.

Challenges and how SkinScreen® Overcomes them

First, most of the measurable challenges regarding systems output/solutions center on the quality of the data. The size and quality of the datasets have a demonstrable impact on the relative accuracy of the outcome. The bottom line is that there are not enough verified datasets of skin lesions available to train a neural network to achieve the level of desirable precision (the point of diminishing return). This shortcoming is impacted with Health Insurance Portability and Accountability Act of 1996, (HIPPA) and other Privacy laws, along with personal preferences.

SkinScreen's approach has overcome this challenge through the use of transformed images from existing datasets. This is performed through image transformation techniques selected from the group consisting of zooming, rotation (0-180 degrees), width shifting, height shifting, shear intensity manipulation, horizontal flipping, vertical flipping, and brightness adjustment. SkinScreen® was able to increase the number of verified images used to train the AI models to over 175,000. The quantity and quality of these images improved SkinScreen's precision and accuracy results dramatically up to a point of diminishing return.

A second challenge is that other systems may require the user's image to be uploaded to their network servers in order to detect and classify the skin lesion. This process leads to less assurance that the user's image will remain private and secure. Medical laws that relate to user privacy, such as HIPAA, would be more difficult to adhere to. SkinScreen® overcomes this challenge by processing the user's data on the ‘edge’ or the user's device. No user data is transmitted over the network and processed or stored on the SkinScreen® application servers.

A third challenge is that other systems ‘FORCE’ a result (or provide a result/prediction for every image interpreted) regardless of whether a skin lesion is present in the image. By selection the best result from a set of poor results is not an optimum strategy to assist in making medical diagnosis predictions.

Based on these challenges, we can see there is a need for improved systems, methods, apparatus, and computer program products for the detection and classification of different types of skin lesions. SkinScreen® provides that capability to the medical community in order to understand, prioritize, and treat individuals based on their skin lesion condition. SkinScreen® decision support tool will be a great asset for any individual or medical organization to leverage upon.

In summary, several key design elements have been included into SkinScreen® to ensure it is a beneficial tool for the user communities:

1. User privacy—All images are to be processed on the ‘edge’ or the user's device and no images are uploaded to SkinScreen® servers. This is performed with the MobileNetV2 architecture and Tensorflow.js libraries.

2. Skin lesion presence—Prior to the classification, the application will determine and inform the user whether a skin lesion can be detected in the image through the use of our ‘serial chain classifiers’.

3. Detection of nine (9)+ classes of skin lesions—Detect more classes of benign and malignant skin lesions and provide better feedback for each user than what is currently available. SkinScreen® can continue to update the models based on new, verified raw images when they are available.

4. Higher accuracy and precision rates than current solutions—Through the use of 175,000 images, the SkinScreen® application is able to account for permutations in nine (9) different skin lesion classes.

5. Real-time feedback—Provide back results in under two seconds since all processing is performed locally on the user's device and involves no network latency.

6. User-friendly tools—Provide useful support tools regardless of the user's background and skillsets. Provide for multi-linguistic capabilities within the application.

7. Multi-platform use—Include support for a web application, mobile devices, and Application Program Interface Representational State Transfer (API REST) service calls by third-party consumers.

8. Expand upon academic and industry research to maximize performance—This was performed through the utilization of the latest versions of TensorFlow and Keras libraries and with supervised machine learning techniques in the development of the SkinScreen® AI models.

9. Analytics—SkinScreen® will calculate the probability that a classification is correct and display that percentage to the user. This capability is unavailable today using current methods.

The present invention implements a two-step approach in detecting and classifying skin lesions. The first step applies a binary classifier to determine whether the image contains enough data of a skin lesion. If not enough data is present then a response is returned back to the user indicating that a lack of data is available to make a prediction. However, if there is enough data present in the image then it uses a multi-class classifier to apply a classification and associated probability in returning back the 3 most probable skin lesion types/classes.

Inclusion of the binary classifier also takes into consideration the case when not enough data is available to make a prediction. SkinScreen® will not FORCE a prediction onto the user, which improves on all cases of classification. An example of a forced prediction is when a picture of a horse is substituted instead of a skin lesion. Other solutions may force the model to apply a classification and percentage to an image, such as the horse, that doesn't contain a skin lesion. SkinScreen® will use the preliminary binary classifier to automatically determine whether the image contains enough data of a skin lesion. If it does, then a multi-class classifier will be applied to the image. The use of a serial binary and multi-classification scheme is unique to the SkinScreen® approach. The benefit of the SkinScreen® approach is that eliminates the need for human interaction in detecting whether a skin lesion is present in the image.

SkinScreen® uses multiple image transformation techniques for creating new expanded datasets using existing verified data. Images in the clinical environment are not always going to be clear, crisp and capture the full skin lesion. By using transformed images, we train the algorithms on less than perfect image sets. This improves the “machine supervised learning” that occurs within Artificial Intelligence. As a result, SkinScreen® has a demonstrable improvement on the relative accuracy and precision of the outcome.

Our methodology and architecture allow for improvement as future datasets are available. And the problem definition can change and the software algorithms can “learn” new features to identify, classify with precision and accuracy beyond human capabilities.

SkinScreen® software leverages 3 forms of Artificial Intelligence (AI) in formulation of the solution. Neural Networks allow the application to sift through data in minute detail, thus allowing the software to learn to recognize patterns that even the most intelligent humans may overlook. Machine learning allows the software application to respond without human interaction to specific tasks it handles. Deep learning combines both neural networks and machine learning to analyze vast amounts of data contained within “Big Data” set images to recognize lesions and make an accurate prediction. This present invention will therefore improve on the ABCDE performance currently employed by trained medical personnel.

SkinScreen® leverages the power of deep learning, a method under AI, to allow quicker and more accurate identification predictions then previously were available. This allows medical professionals to serve more prioritized patients and improving their workflow operations. SkinScreen® is different from other aids because it has the current capability to identify at least nine skin maladies, as well as provide a no determination decision if enough data is not present.

Using our transformation approach, we can increase the number of images that the AI models can use to learn by a factor of eight (8). This enhances the precision of the SkinScreen's AI models to detect, classify and predict beyond the capabilities in which a human without assistance can perform (better).

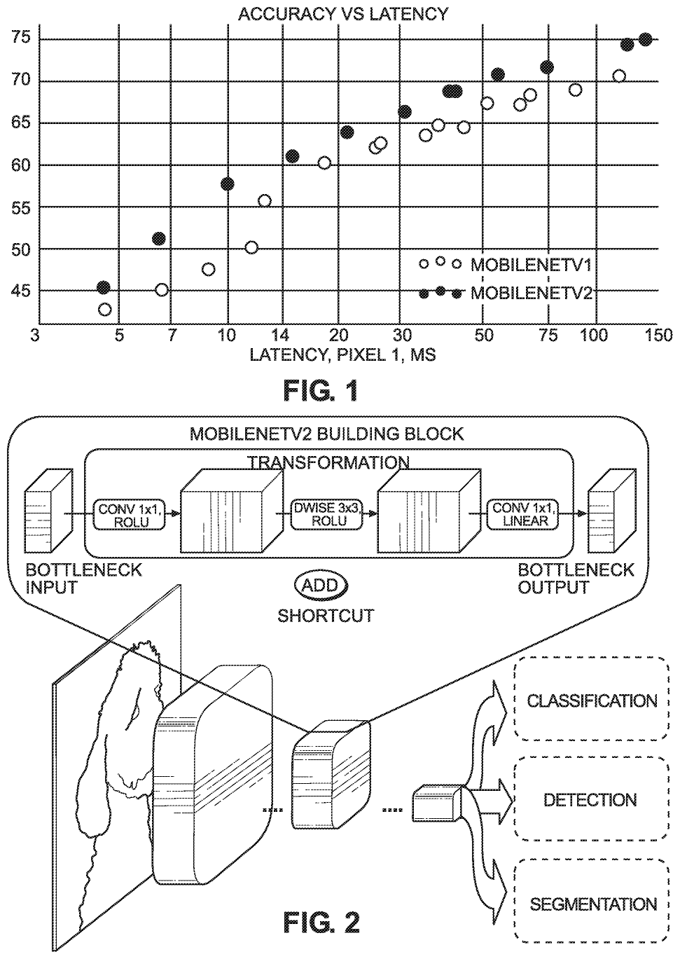

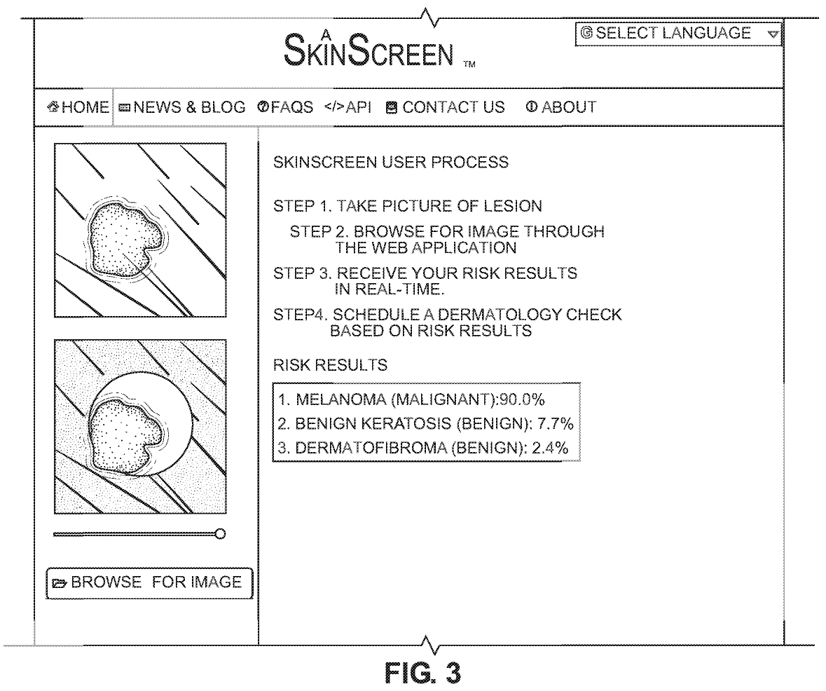

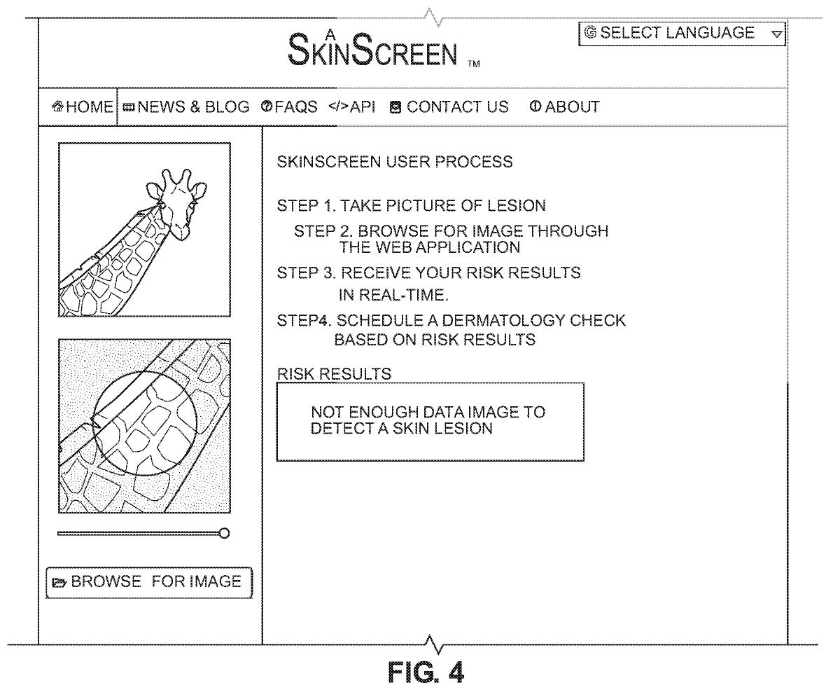

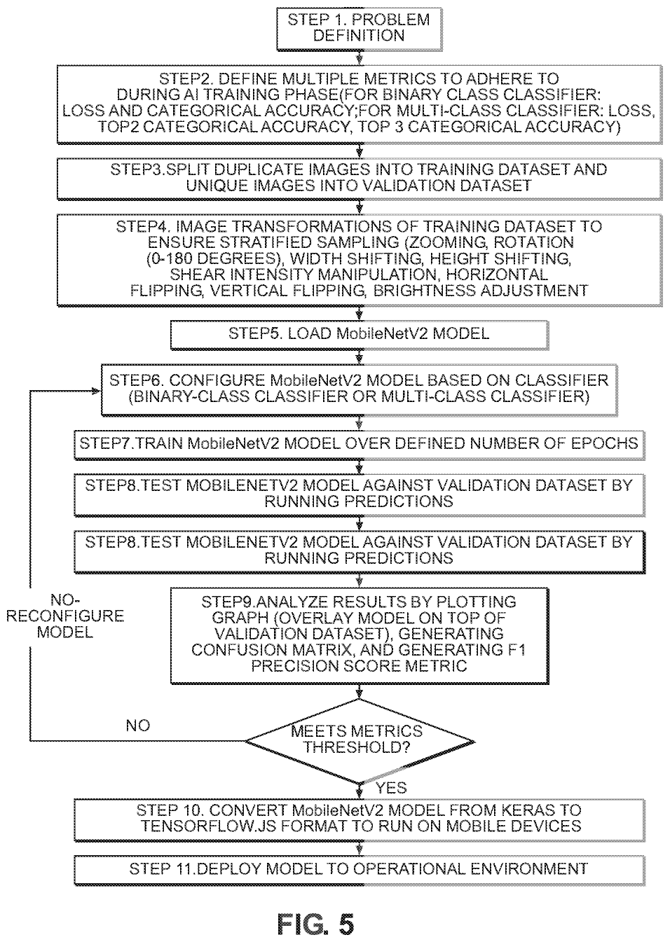

Also, by employing Google's MobileNetV2 architecture for implementations of SkinScreen® the detection and classification will occur on the user's device versus back at a centralized server. A graph showing the accuracy v. latency between MobileNetV1 and MobileNetV2 is shown in reference to FIG. 1.

A model architecture of the MobileNetV2 is shown in reference to FIG. 2. The basic building block is a bottleneck depth-separable convolution with residuals. The architecture of MobileNetV2 contains the initial fully convolution layer with 32 filters, followed by 19 residual bottleneck layers. The researchers have tailored the architecture to different performance points, by using the input image resolution and width multiplier as tunable hyperparameters, that can be adjusted depending on desired accuracy or performance trade-offs. The primary network (width multiplier 1, 224×224), has a computational cost of 300 million multiply-adds and uses 3.4 million parameters. The network computational cost ranges from 7 multiply-adds to 585M MAdds, while the model size varies between 1.7M and 6.9M parameters.

MobileNets are small, low-latency, low-power models parameterized to meet the resource constraints of a variety of use cases. MobileNetV2 improves the state-of-the-art performance of mobile models on multiple tasks and benchmarks as well as across a spectrum of different model sizes. It is a very effective feature extractor for object detection and segmentation. An example of improved performance, for detection function, when paired with Single Shot Detector Lite, shows that MobileNetV2 is about 35 percent faster with the same accuracy than MobileNetV1.

MobileNetV2 has 32 different pre-trained levels of lightweight neural networks that can be customized for use cases depending on what problem needs to be solved The lower levels are used in object detection within an image. They are able to detect simple objects like lines and circles within an image.

The top couple of layers, which SkinScreen® has removed, only focuses on certain objects like trees, cars, people, etc. Replacing the removed layers, our developers added SkinScreen's plurality of skin lesion layers on top of the model through the use of MobileNetV2. These new layers were trained upon SkinScreen's a skin lesion image library suite.

Once the SkinScreen® deep learning models are trained and validation testing has occurred to ensure the Top 3 Categorical Accuracy threshold is met during each epoch, the models are then generated and serialized into a Keras format overwriting the previous successful models that have a lower accuracy threshold. An epoch is the complete presentation of the training data to the architecture. If the validation Top 3 Categorical Accuracy threshold is not met during an epoch, the deep learning models are discarded and the architecture has been configured to automatically reduce the loss value during the next epoch run. And the loss value is the penalty for a bad prediction. This ensures that the architecture will try a different modeling approach during the next epoch.

Once the epochs are completed, the Keras files are then converted over to a Tensorflow.js format, which can be used by the SkinScreen® web application, and a TensorFlow Lite format, that can be used with the mobile apps to complete the SkinScreen® ecosystem.

The new version of MobileNet has several properties that make it suitable for mobile applications development. It allows for very memory-efficient inference and utilizes standard operations present in all neural frameworks. For the ImageNet dataset, MobileNetV2 improves the state of the art for a wide range of performance points. For object detection task, it outperforms real-time detectors on COCO datasets. MobileNetV2 provides a very efficient mobile-oriented model that can be used as a base for many visual recognition tasks, which is why it was chosen as an AI architecture in building the deep learning models in support of SkinScreen®®'s ecosystem.

This aspect ensures a user's privacy since no data is transmitted or stored on SkinScreen's resources. By leveraging MobileNetV2, improved response times are achieved in providing back results to the user in under 2 seconds on average.

Large software systems are composed of many software components. When building and performing maintenance on software tools, such as SkinScreen®, a clear understanding of the dependencies between these components is required. Most software analysis and design methodologies rely on relationships such as “passes date to”, “is a part of”, or “calls or inherits from”. These types of relationships convey important dependency information for design and maintenance functions.

The logic for SkinScreen® may be configured serially. Since most of relationships components are dependent on passing information based on completed functions, elements would not be shuffled, interchanged or reconfigured to cause SkinScreen® to perform identically or with similar function.

Recognizing that an important element within any Artificial Intelligence (AI) tool is the data on which the model was trained. The more data, leads to higher Accuracy (hit) and Precision, up to a point of diminishing return. Our ability to generate additional data sets using existing raw data sets provides SkinScreen® with the ability to achieve Accuracy and Precision beyond normal AI expectations.

SkinScreen® is an AI tool that works to provide greater precision and accuracy in detecting and classifying skin lesions than trained personnel. This degree of accuracy and precision is performed with 3 forms of AI: 1) Neural Networks allow SkinScreen® to sift through big data in minute detail, thus allowing the software to learn to recognize patterns that even the most intelligent humans may overlook, 2) Machine Learning allow SkinScreen® to respond without human interaction to specific tasks it handles, and 3) Deep Learning that combines both neural networks and machine learning to analyze vast amounts of data contained to recognize lesions and make an accurate prediction.

In preferred embodiments of the invention, SkinScreen® does not compare user-derived images with an existing dataset in 1-for-1 comparison. Rather, it takes the training set images and trains its set of AI models based on what features or minute details exist within the training set images for each of the different skin lesion classes/types so that it can predict the classification of a skin lesion when a new image is submitted. During the training phase the model is then verified against the unique images under the validation folder to determine whether the model is an appropriate fit for the data.

A logic gate is provided between the binary classifier and the multi-class classifier. The binary classifier determines whether enough data is available to predict whether a skin lesion is present in the image. If there is not enough data present in the image on skin lesion then a response is returned back to the user that the image does not contain enough data to make a prediction. However, if there is enough data to make a prediction the multi-class classifier is used to predict the 3 skin lesion classes/types that are the most probable and their associated probabilities of accuracy.

Those of skill in the art will have a thorough understanding of software architecture, datasets, statistics, programing skills, and through understanding and experience in Artificial Intelligence. From the hardware aspect, a machine that contains a graphical processing unit (GPU) (preferred) or central processing unit (CPU) in addition to a storage disk that should contain at least 100 gigabytes of disk space. From a software aspect, the following libraries may be present: TensorFlow, Keras, Jupyter, Matplotlib, Numpy, Pandas, MobileNetV2, Tensorflow.js, SciPy, and Python.

The elements for SkinScreen® may include: 1) a significant verified dataset. The dataset allows the neural network to train based on features or minute variations of the images allowing for detection and classification improvement over humans, and 2) neural network algorithms are required for curve fitting of the data. Elements that could be added to make the invention work better include access to more verified datasets, which may allow better accuracy and precision.

In expanding the raw image dataset, image transformations can occur prior to splitting the datasets into training and validation folders. This is reversing Step #3 and Step #4 within the graph. The image transformations may only be implemented on duplicated images in the raw image data set.

In use, SkinScreen® can be accessed through a plurality of platforms, including: a web-based application (through Chrome, Firefox, Safari, and Edge browsers); a smart phone application (that will operate on Android or iOS devices); or through an API service endpoint that can be consumed in JSON format.

The SkinScreen® web application is intended to allow users to provide one (1) photo at a time for prediction. The web application will allow a user to browse for a file on their file system, crop it, resize it, and perform the prediction on the device itself.

The SkinScreen® smart phone application is intended to provide a mobile, customized solution for skin lesion prediction. The application operates on both Android and iOS mobile devices. The smart phone application will allow a user to either take a picture of the lesion for classification or access their photo library on their phone and provide that image for classification.

The SkinScreen® API is intended for third-party customers who need to classify hundreds of images on a periodic basis. The API has service endpoints that can support streaming and batch processing and can run SkinScreen's hosted infrastructure or the customer's infrastructure.

The SkinScreen® software application offers the capability to detect malignant and benign skin lesions in real-time through a highly accurate and precise solution. It produces probability of classification (Identification) of the image that is used as input.

The invention can also be used by students in the medical fields to use as a training aid. Images can appear on a mobile device and the student can make a visual identification of the skin lesion and then get a solution back from the software which would indicate whether the choice was correct or incorrect.

If datasets are available, the problem definition can change and the software algorithms can “learn” new features to identify, classify with precision and accuracy beyond human capabilities.

Other problems that SkinScreen® architecture could address include: 1) detection of Agricultural Crop maladies; 2) DNA analysis of all living things; 3) Military targeting based on overhead imagery (what has changed in the picture over time); 4) Movement of wild animal populations over time (counting the heard, migration of the heard); 5) Detection of dental issues without X-rays; 6) Prediction of snow-pack in mountains to the amount of water made available; or 7) Prediction of successful location for business traffic.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

What is claimed is:

1. A method, using image data of a skin anomaly for detection and classification of skin lesions, the method comprising:
receiving an image of a skin anomaly from a user, the image of the skin anomaly being useable as an input to an artificial intelligence (AI) model trained using a training data set from an existing training set containing a plurality of verified skin lesion images;
applying a binary classifier to the image of the skin anomaly to determine whether the image of the skin anomaly contains sufficient data indicative of a skin lesion;
when insufficient data is present, returning a response to the user indicating that a lack of data is available to make a prediction indicative of the skin lesion; and
when sufficient data is present in the image of the skin anomaly, applying a multi-class classifier of the AI model to apply at least one classification to the image of the skin anomaly.

2. The method of claim 1, further comprising:
determining a probability for each of the at least one classification; and
returning, on a user interface, the probability of the at least one classification.

3. The method of claim 1, further comprising:
transforming at least some of the plurality of verified skin lesion images from the existing training set to expand at least one of a quantity and a quality of the plurality of the verified skin lesion images in the training data set.

4. The method of claim 3, wherein the transforming comprises:
applying an image transformation technique selected from the group consisting of zooming, offset, brightening, blurring, sharpening, color change.

5. The method of claim 1, further comprising:
deploying the AI model to a mobile computing device; and
applying the multi-class classifier of the AI model to the image of the skin anomaly retained locally on the mobile computing device.

6. The method of claim 5, wherein the step of receiving the image of the skin anomaly from the user comprises:
receiving a digital image captured with a digital camera provisioned with a mobile computing device.

7. The method of claim 5, wherein the step of receiving the image of the skin anomaly from the user comprises:
presenting, in a display, a plurality of images from a user image library accessible by the mobile computing device; and
receiving a user selection of the image of the skin anomaly from the user image library.

8. The method of claim 5, further comprising:
converting the AI model to a format configured to run on the mobile computing device.

9. An analysis apparatus configured to use an image of a skin anomaly to determine a classification of a skin lesion, the analysis apparatus comprising:
at least one processor configured to execute computer-readable instructions to cause the analysis apparatus to run an artificial intelligence (AI) model to classify the image of the skin anomaly into at least one of a plurality of classifications; the AI model trained using a training data set from an existing training set containing a plurality of verified skin lesion images;
applying, by the processor, a binary classifier to the image of the skin anomaly to determine whether the image of the skin anomaly contains sufficient data indicative of a skin lesion; and
when sufficient data is present in the image of the skin anomaly, applying a multi-class classifier of the AI model to apply at least one classification to the image of the skin anomaly.

10. The analysis apparatus of claim 9, further comprising:
when insufficient data is present, returning a response to a user indicating that a lack of data is available to make a prediction indicative of the skin lesion.

11. The analysis apparatus claim 9, further comprising:
determining, by the AI model, a probability for each of the at least one classification; and
returning, on a user interface, the probability of the at least one classification.

12. The analysis apparatus of claim 9, wherein the existing training set is transformed in at least one of a quantity and a quality of the plurality of the verified skin lesion images to augment the training data set.

13. The analysis apparatus of claim 12, wherein the training set is transformed by applying an image transformation technique to at least some of the plurality of verified skin lesion images, wherein the image transformation technique is selected from the group consisting of zooming, offset, brightening, blurring, sharpening, color change.
